(19) United States
(12) Patent Application Publication
(10) Pub. No.: US 2023/0136777 A1
(43) Pub. Date: May 4, 2023

(54) COMMUNICATION CHANNEL INTO A CONFERENCE SESSION OF A SUBSEQUENT MEETING WHEN A CURRENT MEETING OVERRUNS

(71) Applicant: Avaya Management L.P., Durham, NC (US)

(72) Inventors: Sanjog Kotnis, Pune (IN); Satish Marathe, Pune (IN)

(21) Appl. No.: 17/519,282

(22) Filed: Nov. 4, 2021

(51) Int. Cl. H04L 12/18

(52) U.S. Cl. CPC H04L 12/1818; H04L 12/1827

(57) ABSTRACT

The technology disclosed herein enables establishment of a communication channel into a subsequent conference session upon determining that a current meeting will overrun. In a particular embodiment, a method includes, during a first meeting, determining a participant in the first meeting that is scheduled to participate in a second meeting following the first meeting. The participant operates a participant endpoint to participate in the first meeting over a first conference session. The method also includes performing an overrun check that results in an overrun determination that the first meeting is going to extend beyond a scheduled start time of the second meeting. In response to the overrun determination, the method includes establishing a communication channel between the participant endpoint and a second conference session for the second meeting. The method further includes transmitting information from the participant over the communication channel to the second conference session.

### TECHNICAL BACKGROUND

Communications between people in the modern world increasingly occurs over remote meetings. Rather than two or more people meeting in person, a conference session can be established between their computing devices to allow the people to talk to, and even see, one another in real-time. Given that an individual can attend multiple remote meetings from the same physical location (e.g., rather than having to move meeting rooms), the individual's meetings can be scheduled one right after another. However, the remote aspect of a meeting does not prevent the meeting from running long. Thus, it is still entirely possible for a meeting participant to not be present in a subsequent meeting due to a previous meeting running long. Other participants in the subsequent meeting may then be left unaware of a reason for the meeting participant's absence or how long it might be until the participant arrives.

### SUMMARY

The technology disclosed herein enables establishment of a communication channel into a subsequent conference session upon determining that a current meeting will overrun. In a particular embodiment, a method includes, during a first meeting, determining a participant in the first meeting that is scheduled to participate in a second meeting following the first meeting. The participant operates a participant endpoint to participate in the first meeting over a first conference session established between the participant endpoint and other participant endpoints. The method also includes performing an overrun check. The overrun check results in an overrun determination that the first meeting is going to extend beyond a scheduled start time of the second meeting. In response to the overrun determination, the method includes establishing a communication channel between the participant endpoint and a second conference session for the second meeting while the participant endpoint remains on the first conference session. The method further includes transmitting information from the participant over the communication channel to the second conference session.

In some examples, in response to reaching a threshold amount of time prior to a scheduled end time of the first meeting, the method includes prompting the participant about whether the overrun check should be performed. In response to prompting the participant, the method includes receiving an instruction to perform the overrun check.

In some examples, the method includes determining whether core participants for the second meeting are available for the second meeting and, in response to determining that there are one or more unavailable participants of the core participants, notifying the participant about the unavailable participants. In those examples, in response to determining that there are one or more unavailable participants of the core participants, the method may include canceling the second meeting.

In some examples, in response to the overrun determination, the method includes presenting a status of the second meeting to the participant.

In some examples, in response to the overrun determination, the method includes presenting an estimated overrun time to the participant, wherein the information includes the estimated overrun time.

In some examples, the communication channel comprises a text chat channel and wherein the information comprises text entered by the participant into the participant endpoint.

In some examples, an interface for the communication channel is presented by a client application executing on the participant endpoint to connect the participant endpoint to the first conference session. In those examples, the interface may present an estimated overrun time and wherein the information includes the estimated overrun time.

In some examples, the information is presented to one or more participants via the second conference session.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to, during a first meeting, determine a participant in the first meeting that is scheduled to participate in a second meeting following the first meeting. The participant operates a participant endpoint to participate in the first meeting over a first conference session established between the participant endpoint and other participant endpoints. The program instructions also direct the processing system to perform an overrun check. The overrun check results in an overrun determination that the first meeting is going to extend beyond a scheduled start time of the second meeting. In response to the overrun determination, the program instructions direct the processing system to establish a communication channel between the participant endpoint and a second conference session for the second meeting while the participant endpoint remains on the first conference session. The program instructions further direct the processing system to transmit information from the participant over the communication channel to the second conference session.

### BRIEF DESCRIPTION OF THE DRAWINGS

FIG. 1 illustrates an implementation for establishing a communication channel into a conference session for a subsequent meeting.

FIG. 2 illustrates an operation to establish a communication channel into a conference session for a subsequent meeting.

FIG. 3 illustrates an operational scenario for establishing a communication channel into a conference session for a subsequent meeting.

FIG. 4 illustrates an implementation for establishing a communication channel into a conference session for a subsequent meeting.

FIG. 5 illustrates an operational scenario for establishing a communication channel into a conference session for a subsequent meeting.

FIG. 6 illustrates another operational scenario for establishing a communication channel into a conference session for a subsequent meeting.

FIG. 7 illustrates a display system for establishing a communication channel into a conference session for a subsequent meeting.

FIG. 8 illustrates a display system for establishing a communication channel into a conference session for a subsequent meeting.

FIG. 9 illustrates a computing architecture for establishing a communication channel into a conference session for a subsequent meeting.

### DETAILED DESCRIPTION

The conference systems described herein establish communication channels into conference sessions of subsequent meetings to allow absent participants to communicate with participants who have already joined the subsequent meeting. In particular, a conference system determines that a current meeting, being held over a current conference session, is going to overrun its scheduled end time. For one or more participants in the current meeting that are scheduled to attend a subsequent meeting, the conference system establishes a communication channel from the current conference session into a conference session of the subsequent meeting. Information can be provided to participants in the subsequent conference session over the communication channel. The information may simply indicate that one or more participants are absent because they are in a previous meeting that has, or will, overrun its scheduled end time, may provide an estimate for when the participants will be able to join the subsequent meeting, or may provide some other information that may be relevant to the participants of the subsequent meeting. Regardless of what the information includes, the subsequent meeting participants need not look outside of their interface into the subsequent conference session for the information (e.g., need not check their email for information from the absent participants). Similarly, the participants on the current meeting need not look outside of their interface into the current conference session to provide the information (e.g., need not draft an email to the participants of the subsequent meeting).

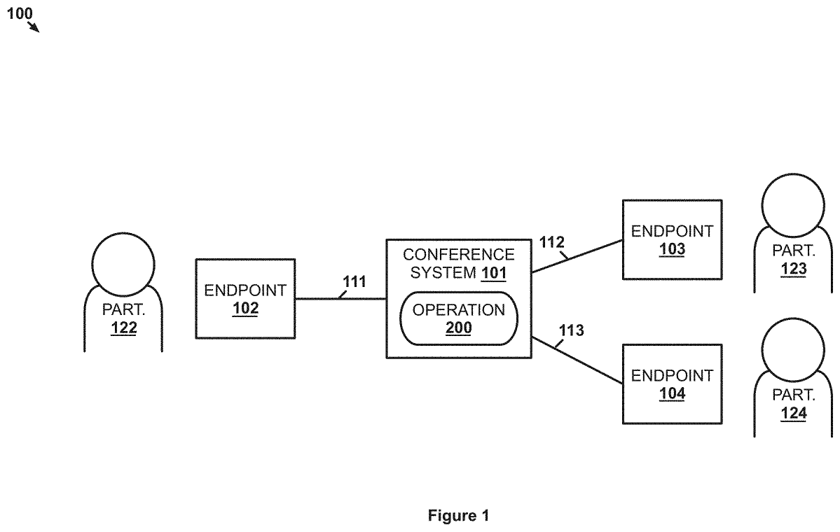

FIG. 1 illustrates implementation 100 for establishing a communication channel into a conference session for a subsequent meeting. Implementation 100 includes conference system 101, endpoint 102, endpoint 103, and endpoint 104. Participant 122 operates endpoint 102, participant 123 operates endpoint 103, and participant 124 operates endpoint 104. Conference system 101 and endpoint 102 communication over communication link 111. Conference system 101 and endpoint 103 communicate over communication link 112. Conference system 101 and endpoint 104 communicate over communication link 113. Communication links 111-112 are shown as direct links but may include intervening systems, networks, and/or devices.

In operation, endpoints 102-104 may each respectively be a telephone, tablet computer, laptop computer, desktop computer, conference room system, or some other type of computing device capable of connecting to a conference session facilitated by conference system 101. Conference system 101 facilitates conference sessions between two or more endpoints, such as endpoints 102-104. While shown as a single device, conference system 101 may be distributed across multiple devices. A conference session may be audio only (e.g., a voice call) or may also include a video component (e.g., a video call), a graphic component (e.g., presentation slides, screen sharing, etc.), text chat component, and/or some other type of real-time communication. For example, during a conference session between endpoints 102-104, participants 122-124 are able to speak with, or to, one another by way of their respective endpoints 102-104 capturing their voices and transferring the voices over the conference session.

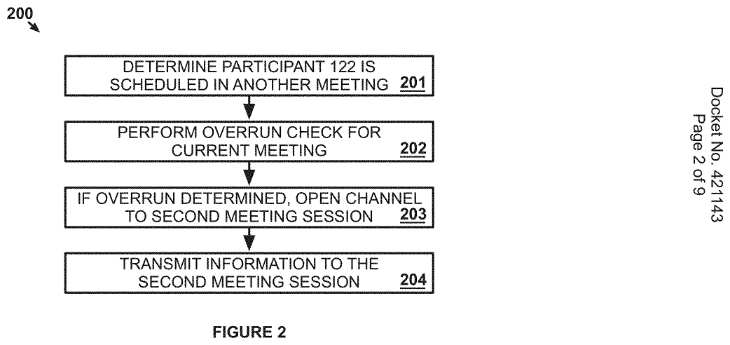

FIG. 2 illustrates operation 200 to establish a communication channel into a conference session for a subsequent meeting. Conference system 101 performs operation 200 to establish the communication channel during a current conference session that is currently established between endpoint 102 and one or more other endpoints (which may include at least one of endpoint 103 and endpoint 104). The current conference session allows participant 122 to communicate with other participant(s), operating the other endpoint(s), in a current meeting that is held over the current conference session. During the current meeting, conference system 101 determines that participant 122 is scheduled to participate in a second meeting following the current meeting (201). Conference system 101 may maintain a record of all conference sessions scheduled to be facilitated by conference system 101 and a list of participants for each of the conference sessions. Conference system 101 may then identify within that record that participant 122 is scheduled to participate in a meeting following the current meeting. Alternatively, conference system 101 may have access to an electronic calendar of participant 122 that includes an entry for the second meeting that indicates a second conference session facilitated by conference system 101 will be used for the second meeting (e.g., may include a link to conference system 101, dial-in information for conference system 101, or some other information indicative of a second conference session). Other manners of determining that participant 122 is scheduled in the second meeting may also be used.

Conference system 101 also performs an overrun check on the current meeting (202). The overrun check may be performed when the current meeting reaches a predefined amount of time before its scheduled end time. The overrun check may only be performed if a participant in the current meeting has a subsequent meeting scheduled that could possibly be affected by the current meeting exceeding its scheduled end time. The overrun check determines whether the current meeting is going to extend beyond its scheduled end time. In this example, the overrun check results in an overrun determination that the current meeting is going to extend beyond a scheduled start time of the second meeting. Conference system 101 may determine that the current meeting is going to overrun by querying a participant in the current meeting (e.g., asking for an amount of time remaining in the meeting) or may estimate the amount of time remaining in the current meeting from information available to conference system 101. The information may include materials being used in the present meeting (e.g., presentation slides, agendas, documents, etc.), present context of the current meeting from processing speech of the participants (e.g., to determine based on the words being spoken how far along the participants are in the meeting agenda), historical tendencies of participants to overrun, or some other type of information that may be indicative of whether a meeting is going to overrun—including combinations thereof. In an example, conference system 101 may determine a number of slides remaining in a presentation being presented over the current communication session for the current meeting and estimate how long it will take to get through the remaining slides (e.g., based on an average amount of time spent on each slide already covered in the presentation). In another example, conference system 101 may determine that past meetings of the moderating participant of the current meeting overrun by an average of ten minutes. That fact alone may indicate to conference system 101 that the current meeting is going to overrun or conference system 101 may use additional items of information to determine a final overrun estimate (e.g., even though the average is ten minutes, conference system 101 may determine that there is too much left on the meeting agenda for the current meeting to finish within the ten minutes).

In response to the overrun determination, conference system 101 establishes a communication channel between endpoint 102 and a second conference session for the second meeting while endpoint 102 remains on the current conference session for the current meeting (203). Had conference system 101 determined that the current meeting would not overrun, then conference system 101 would not establish a communication channel. The communication channel may be voice, video, text, or some other mode of conveying information between endpoints and may use any protocol supported by conference system 101. Endpoint 102 may present the communication channel to participant 122 in an interface for the current communication session that is already being presented by endpoint 102. For example, a new window (or other type of display section) to access the communication channel may pop up in a conference client application executing on endpoint 102 to connect to conference sessions facilitated by conference system 101. In this example, endpoint 103 and endpoint 104 are connected to the second conference session when the communication channel is established. Although, in other examples, no endpoint may have yet joined the second conference session when the communication channel is established (i.e., the communication channel may be open so that it is ready to convey information, or already conveyed information will be waiting, when an endpoint does connect to the second conference session).

An interface to the communication channel is also presented at endpoint 103 and endpoint 104 (or will be once each endpoint joins the second conference session if they have not already). The interface may be similar to that presented to endpoint 102 (e.g., may be a popup window of a conference client application) may be presented for the communication channel at endpoint 103 and endpoint 104. In some examples, conference system 101 may bridge the communication channel into a second communication channel of the second conference session. In those examples, information transmitted over the communication channel from endpoint 102 may be received and presented by endpoint 103 and endpoint 104 in the interface to the second communication channel. For example, the second conference session may include a chat channel that supplements voice/video communications being exchanged between participants. Information received over the communication channel from endpoint 102 may be presented in the interface to that chat channel, rather than a separate interface element (e.g., text from participant 122 may display in the chat feed even though participant 122 has not joined the second communication session).

After establishment of the communication channel, conference system 101 transmits information received from participant 122 over the communication channel to the second conference session (204). The information may be input by participant 122 into endpoint 102 (e.g., typed, spoken, etc.), may be suggested to participant 122 via endpoint 102 by conference system 101 (e.g., may include a suggested time in which they will be delayed by the overrun), or may include some other type of information that participant 122 may wish to convey over the communication channel to participants in the second conference session. The information is presented to participant 123 and participant 124 by their respective endpoints 103 and 104 upon receipt or when each endpoint connected to the second communication session. Effectively, the information is broadcast to anyone participating in the second meeting through an endpoint to the second communication session. Participant 123 and participant 124, along with any other participants in the second meeting, are made aware of the information without having to resort to other mechanisms of communication outside of the conference session (e.g., email, instant messaging, etc.). In some examples, if more than just participant 122 are on the current meeting and scheduled for the second meeting, then the endpoints of those additional participants may also be connected to the communication channel. Thus, any one of the participants may provide information for transmission into the second conference session via the communication channel.

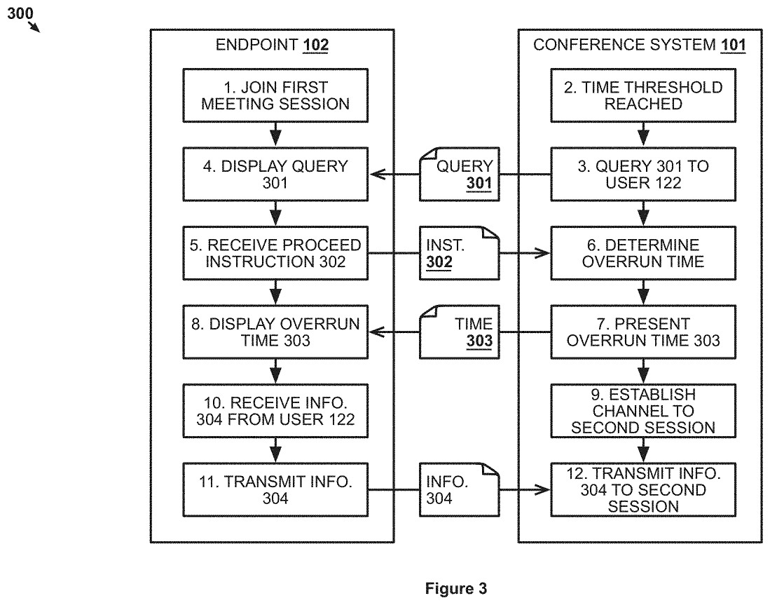

FIG. 3 illustrates operational scenario 300 for establishing a communication channel into a conference session for a subsequent meeting. Operational scenario 300 is an example of what may be performed at endpoint 102 and conference system 101 when conference system 101 is performing operation 200. In operational scenario 300, endpoint 102 joins a first conference session for a first meeting at step 1. The first conference session is facilitated by conference system 101 between endpoint 102 and one or more other endpoints that are not shown. Participant 122 participates in the first meeting with participants at the one or more other endpoints over the first conference session. While endpoint 102 is on the first conference session, conference system 101 determines at step 2 that a threshold amount of time (e.g., five minutes) before the scheduled end time of the first meeting has been reached. In response to the threshold being reached, conference system 101 transmits query 301 to endpoint 102 at step 3. In this example, query 301 is transmitted to endpoint 102 because conference system 101 has determined that participant 122 has a second meeting scheduled shortly (e.g., within a threshold amount of time) after the first meeting was scheduled to end. Query 301 asks participant 122 about whether they want an overrun check to be performed on the first meeting. In some examples, query 301 may also ask participant 122 about how much time they believe the first meeting is going to overrun, the answer to which may be used when conference system 101 makes the overrun determination. Query 301 may be transmitted in a messaging protocol compatible with a client application executed by endpoint 102 to connect to conference system 101 and the first conference session (e.g., Session Initiation Protocol (SIP)). Other types of messaging protocols may also be used.

Upon receipt of query 301, endpoint 102 displays query 301 at step 4 to participant 122. Query 301 may be presented using a dedicated user interface element (e.g., window) or may be presented within an element already enabled as part of the first conference session. For example, the first conference session may include a chat channel with an interface thereto. Query 301 may be presented in that chat channel interface (e.g., as a message indicated to be from conference system 101 rather than from another participant in the first meeting).

Regardless of how query 301 is presented, endpoint 102 provides an interface into which participant 122 can respond to query 301. Endpoint 102 receives proceed instruction 302 at step 5 via that interface. For example, if query 301 is presented in a popup window, the popup window may include a button for participant 122 to indicate that they want conference system 101 to proceed with the overrun check and another button for participant 122 to indicate that they do not want conference system 101 to proceed with the overrun check. Alternatively, if query 301 is presented in a chat interface of the first meeting, participant 122 may input proceed instruction 302 into a text entry box for the chat interface (e.g., may type “yes” in response to being asked whether the overrun check should be performed).

Proceed instruction 302 is transmitted to conference system 101 after receipt from participant 122 and conference system 101 performs an overrun check to determine overrun time 303 at step 6 in response to proceed instruction 302. Proceed instruction 302 may be transmitted to conference system 101 in the same protocol in which query 301 was transmitted to endpoint 102. Conference system 101 determines overrun time 303 in a manner similar to that discussed above with respect to operation 200. Once overrun time 303 has been determined, conference system 101 presents overrun time 303 to participant 122 at step 7 by transmitting overrun time 303 to endpoint 102, which displays overrun time 303 at step 8. Query 301 may be transmitted in a message similar to query 301 and proceed instruction 302. Query 301 may likewise be displayed in the same interface (e.g., window or chat channel) in which endpoint 102 displayed query 301.

In addition to presenting overrun time 303 to participant 122, conference system 101 establishes a communication channel act step 9 into a second conference session over which participants in the second meeting will communicate. The communication channel enables participant 122 to share information with participants with endpoints joined to the second conference session even though endpoint 102 has not yet joined the second conference session and is still joined to the first conference session. Endpoint 102 receives information 304 from participant 122 at step 10 for transmission over the communication channel. In this example, the interface used to display overrun time 303 to participant 122 also prompts participant 122 to enter information 304 for transmission over the communication channel (e.g., provides a text entry box for a text message). In a basic example, participant 122 may simply indicate that overrun time 303 should be included in information 304 and shared with participants on the second conference session. In some examples, participant 122 may be able to adjust overrun time 303 before overrun time 303 is sent and/or provide a message to the participants in the second meeting (e.g., tell the other participants that they get started without participant 122). Once information 304 is received, endpoint 102 transmits information 304 at step 11 to conference system 101, which transmits information 304 into the second conference session at step 12.

By transmitting information 304 into the second conference session, endpoint 103 and endpoint 104 receive information 304 and present information 304 to participants 123 and 124 when endpoint 103 and endpoint 104 connect to the second conference session (if they are not connected already). Since the communication channel is a channel into the second conference session, information 304 is presented by endpoint 103 and endpoint 104 by an interface that participant 123 and participant 124 use to connect to the second meeting. For example, information 304 may be presented in a popup window displayed by a conference client application that connects endpoint 103 and endpoint 104 to the second conference session. Participant 123 and participant 124 do not need to look outside of the application used to join the second conference session for information 304 received from participant 122. In this example, so as not to distract participant 122 from the first meeting, the communication channel is a one-way channel from participant 122 to participants in the second meeting.

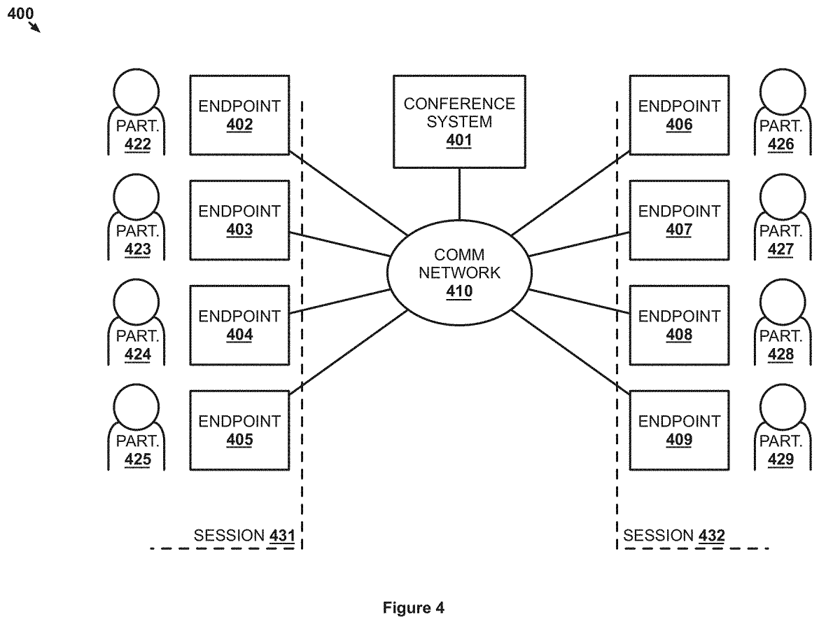

FIG. 4 illustrates implementation 400 for establishing a communication channel into a conference session for a subsequent meeting. Implementation 400 includes conference system 401, endpoints 402-409, and communication network 410. Communication network 410 includes one or more local area networks and/or wide area computing networks, including the Internet, over which systems 401-409 communicate. Endpoints 402-409 may each comprise a telephone, laptop computer, desktop workstation, tablet computer, conference room system, or some other type of user operable computing device. Conference system 401 may be an audio/video conferencing server, a packet telecommunications server, a web-based presentation server, or some other type of computing system that facilitates user communication sessions between endpoints. Endpoints 402-409 each execute a conference client application that enables endpoints 402-409 to join conference sessions facilitated by conference system 401. In this example, endpoints 402-405 are connected to conference session 431 and endpoints 406-409 are connected (or will be connected) to conference session 432, which is scheduled to start after conference session 431 ends.

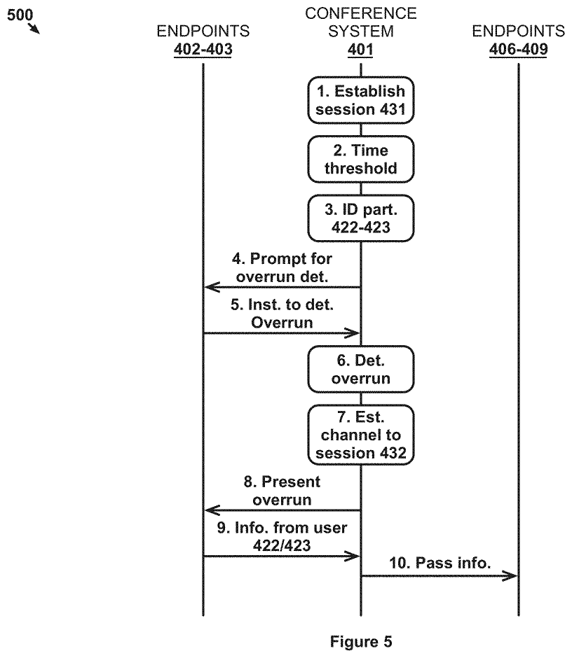

FIG. 5 illustrates operational scenario 500 for establishing a communication channel into a conference session for a subsequent meeting. In operational scenario 500, conference system 101 establishes conference session 431 at step 1 between endpoints 402-405. Conference session 431 may be a voice or video conference session. Conference session 431 may include other communication channels as well, such as a text chat or screen sharing channel. Participants 422-425 participate in a meeting over conference session 431 via their respective endpoints 402-405. Conference system 401 then determines at step 2 that a threshold amount of time before the meeting is scheduled to end has been reached while conference session 431 remains established. For example, if the meeting of conference session 431 is scheduled to end at 11:00am and the threshold is set to ten minutes, then the threshold would be reached at 10:50am. In response to the threshold being reached, conference system 401 identifies participants 422-423 at step 3 as being participants on conference session 431 that are scheduled to participate in a meeting over conference session 432 after conference session 431 has ended.

Conference system 401 prompts participants 422-423 at step 4 via endpoints 402-403 to query participants 422-423 about whether either of them want conference system 401 to perform an overrun check on the meeting of conference session 431. For example, conference system 401 may transmit a query like query 301 above to endpoints 402-403 for presentation to participants 422-423 thereat. In response to the prompt, conference system 401 receives an instruction at step 5 to perform the overrun check. For example, conference system 401 may receive a proceed instruction like proceed instruction 302. The instruction to proceed may be received from one or both of endpoints 402-403, as conference system 401 may only require the proceed instruction from one of the participants.

In response to receiving the instruction to proceed with the overrun check, conference system 401 determines at step 6 whether the meeting being held over conference session 431 is going to overrun and for how long. Conference system 401 may query one or more of participants 422-425 for their estimates regarding how long the meeting will continue and/or may determine the overrun time using information gathered from other sources, as discussed above. When conference system 401 determines that the meeting is going to overrun into a scheduled start time of a subsequent meeting to be held over conference session 432, conference system 401 establishes a communication channel at step 7 into conference session 432. Since conference system 401 facilitates both conference session 431 and conference session 432, conference system 401 may use any channel mechanism at its disposal to create a communication channel that bridges conference session 431 and conference session 432. For example, conference client applications executing on endpoints 402-409 may include instructions that provide an interface to the communication channel.

In this example, conference system 401 presents an overrun time determined during the overrun check to endpoints 402-403 at step 8. The overrun time may indicate an amount of time that the current meeting on conference session 431 is going to overrun its scheduled end time or may indicate an amount of time in which participants 422-423 are going to be late to the meeting on conference session 432. For example, conference system 401 may determine that the current meeting is going to overrun its scheduled end time by 15 minutes. The overrun time presented may, therefore, be 15 minutes. Alternatively, if the second meeting that will be held over conference session 432 is scheduled to start 5 minutes after the current meeting ends, then the overrun time may present 10 minutes because that is the amount of time participants 422-423 are expected to be late joining conference session 432. Regardless, the overrun time is presented in an interface to the communication channel at endpoints 402-403. Participants 422-423 may each instruct their respective endpoints 402-403 to send the overrun time in information over the communication channel into conference session 432 and/or may provide additional information (e.g., via text input) into the interface to send over the communication channel. The information received from either or both of participants 422-423 is send over the communication channel at step 9 to conference system 401, which passes the information into conference session 432 at step 10. In this example, endpoints 406-409 are already connected to conference session 432 and, therefore, receive the information immediately for presentation to their respective participants 425-429. In other examples, if the information has been passed into conference session 432 prior to an endpoint joining, then the information will be received by the endpoint when the endpoint does connect to conference session 432 (e.g., will already be populated in a chat window of the conference client application along with other chat communications between endpoints 406-409).

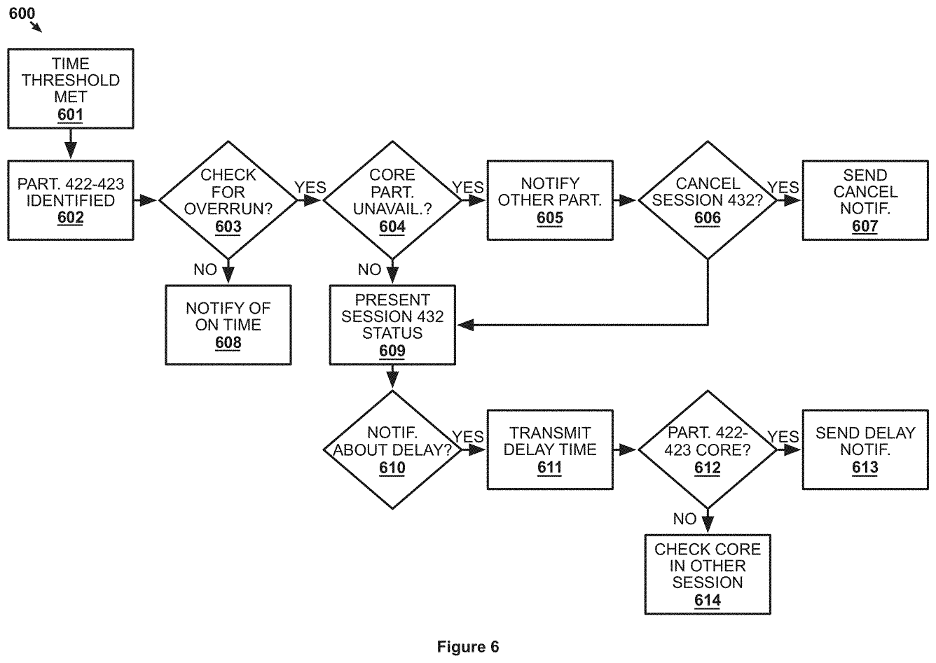

FIG. 6 illustrates operational scenario 600 for establishing a communication channel into a conference session for a subsequent meeting. Operational scenario 600 is an example where conference system 401 considers whether participants 422-423 are core participants to the meeting over conference session 432. Operation 200 discussed above may also benefit from the core participant considerations described in operational scenario 600. A core participant is a participant that is important to a meeting such that the meeting may not be worth having without one or more of the core participants. A calendar invite establishing the meeting may explicitly indicate to conference system 401 which participants are core, conference system 401 may infer from the calendar invite which participants are core (e.g., the participants in the “to” field of the invite may be core participants while participants that are in the “cc” field may not be core participants), conference system 401 may analyze conference materials for the meeting to determine which participants are core (e.g., may determine the authors of a presentation are core participants or or may determine that participants explicitly mentioned in a meeting agenda are core participants), conference system 401 may query participants scheduled to join conference session 432 about whether they are core participants, or conference system 401 may determine that a participant is a core participant in some other manner—including combinations thereof.

Operational scenario 600 begins when conference system 401 determines that a time threshold has been met prior to the scheduled end time of the current meeting being held over conference session 431 (601). Conference system 401 identifies that participants 422-423 are scheduled to participate in a meeting over conference session 432 (602) and queries participants 422-423 via endpoints 402-403 about whether participants 422-423 want conference system 401 to perform an overrun check (603). In this example, if neither participant 422 nor participant 423 indicate that they wish a overrun check be performed, then conference system 401 opens a communication channel into conference session 432 and notifies participants connected to conference session 432 that participants 422-423 are going to be on-time (608). In some examples, if one of participants 422-423 indicates that they do not want the overrun check to be performed, then conference system 401 may only notify that the one participant is going to be on time (e.g., the one participant may be planning on joining conference session 432 on time regardless of the overrun).

If one or more of participants 422-423 indicate that they do want an overrun check to be performed, then conference system 401 determines whether core participants to the meeting over conference session 432 are unavailable (604). Conference system 401 may determine that a core participant is unavailable by finding an “away” presence status for the participant in a presence server, by determining that an out-of-office auto-reply message is set up in the participant's email account, by querying the core participant (e.g., through email or text message), or may determine the participant's unavailability in some other manner—including combinations thereof. In some examples, conference system 401 may only determine that the core participants are unavailable if all core participants are unavailable, may determine that core participants are unavailable unless at least one core participant is available, or may determine that the core participants are unavailable if a predefined portion of the core participants are unavailable (e.g., 50% or more of the core participants are unavailable). In some examples, one or more of participants 422-423 may be core participants.

In response to determining that the core participants are unavailable, conference system 401 notifies other participants on conference session 432 (or scheduled to be connected to conference session 432) that the core participants are unavailable (605). The notification may be presented through conference session 432 and/or conference session 431 (e.g., via a conference client interface on the endpoints) and/or may use a different communication mode (e.g., email or text). In some examples, conference system 401 may indicate which of the core participants are unavailable in the notification. Conference system 401 also determines whether the meeting over conference session 432 should be canceled due to the unavailability of the core participants (606). Conference system 401 may determine that the meeting should be canceled only if all core participants are unavailable or if a predefined portion (e.g., 50%) of the core participants are unavailable. In some examples, conference system 401 may query other participants of the meeting about whether the meeting should be canceled after notifying the participants about the core participant unavailability. If conference system 401 determines that the meeting should be canceled, conference system 401 sends a meeting cancelation notification to the participants of the meeting, which includes participants 422-423 (607). The notification may be implemented by deleting the calendar invite for the meeting which propagates to the calendars of participants on the meeting. The participants' respective calendar applications may then alert the participants to the cancelation. In some examples, the deletion of the calendar invite also triggers an email be sent to the participants, which alerts the participants to the cancelation. Other forms of notifying participants may also/instead be used.

If conference system 401 determines that the core participants are not unavailable (e.g., one or more are available) or determines otherwise that the meeting should not be canceled, then conference system 401 presents a status of conference session 432 to participants 422-423 (609). The status may indicate that conference session 432 is still expected to begin on time for the meeting, a list of participants determined to still be available for the meeting, a list of participants already joined to conference session 432, an amount of time participants 422-423 will likely be delayed for joining conference session 432, as determined by the overrun check, or some other information that participants 422-423 may find useful regarding conference session 432.

In this example, after (or while) conference system 401 present the status of conference session 432, conference system 401 queries participants 422-423 about whether they want to notify participants on conference session 432 about the delay time (i.e., overrun time with respect to the scheduled start of conference session 432) (610). In response to one or more of participants 422-423 indicating that participants on conference session 432 should be notified about the delay time, conference system 401 transmits the delay time in information over a communication channel established into conference session 432 (611). Endpoints 406-409 present the delay time to their respective participants 425-429.

Also, in this example, conference system 401 determines whether to delay conference session 432 if either or both of participants 422-423 are core participants (612). Conference system 401 may query participants 422-423 about whether either of them wants to delay conference session 432, may delay conference session 432 by default if either or both of participants 422-423 are delayed, or may determine to delay conference session 432 by some other means. If conference system 401 determines that conference session 432 should be delayed, conference system 401 sends a delay notification to participants on conference session 432 (613). The delay notification may be sent over the communication channel into conference session 432 to notify participants 425-429 via their respective endpoints 406-409 connected to conference session 432, may update the calendar invite for the meeting to account for the delay, or may notify participants in some other manner—including combinations thereof. If participants 422-423 are not core participants or conference system 401 has otherwise determined that conference session 432 should not be delayed on their account, conference system 401 checks for core participants in other conference sessions (614). Should core participants to conference session 432 also currently be in meetings that are going to overrun, conference system 401 may determine based on those core participants that conference session 432 should still be delayed and delay conference session 432 accordingly. Conference system 401 may have also performed the above steps with respect to the participants in those other sessions as well.

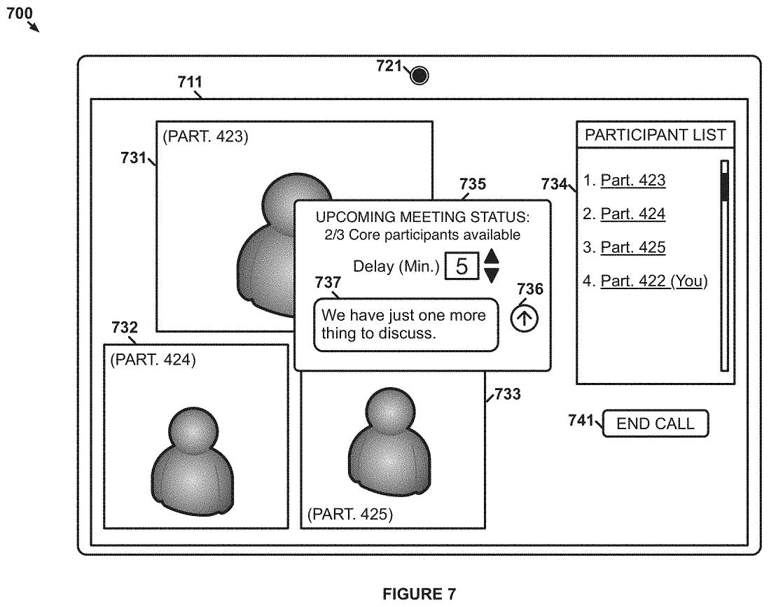

FIG. 7 illustrates display system 700 for establishing a communication channel into a conference session for a subsequent meeting. Display system 700 is an example display system for endpoint 402, although, endpoint 403 may include a similar display system that performs similarly. Display system 700 includes display 711 and camera 721. Display 711 may be a cathode ray tube (CRT), Liquid Crystal Display (LCD), Light Emitting Diode display (LED), or some other type of display capable of presenting images described below. Camera 721 includes optics and an image sensor for capturing video of a participant viewing display 711. Camera 721 may be omitted in some examples. In some examples, display system 700 may further include a microphone and/or one or more speakers for participant 422 to input and receive voice communications over conference sessions.

In this example, endpoint 402 is currently connected to conference session 431, which is a video conference session, using a conference client application. Display 711 is displaying an example Graphical User Interface (GUI) for the conference client application. The GUI shows participant windows 731-733, participant list 734, communication channel window 735, and end call button 741, which ends endpoint 402′s connection to conference session 431 when pressed. Real-time video of participant 423 is shown in participant window 731, which is larger than participant window 732 and participant window 733 because participant 423 is currently speaking. Participant window 732 shows real-time video of participant 424 and participant window 733 shows real-time video of participant 425. Participant list 734 lists participants 422-425 as participants on conference session 431.

Communication channel window 735 is displayed in response to conference system 401 sending endpoint 402 a meeting status for the meeting scheduled to occur over conference session 432. In this case, the status indicates that 2/3 of the core participants that are scheduled to join conference session 432 are available and indicates that conference system 401 has determined, during an overrun check, that participant 422 will be delayed in joining conference session 432 by 5 minutes. Communication channel window 735 allows participant 422 to adjust the number of minutes up or down and allows participant 422 to enter a message into text entry box 737. Upon participant 422 selecting send button 736, the information from communication channel window 735 (i.e., the delay time and the message) is send via a communication channel that conference system 401 has established into conference session 432.

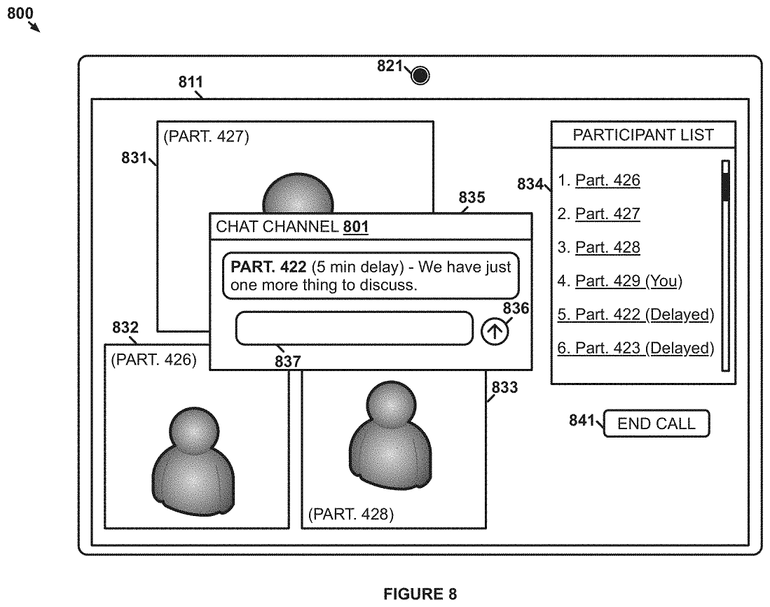

FIG. 8 illustrates display system 800 for establishing a communication channel into a conference session for a subsequent meeting. Display system 800 is an example display system for endpoint 409, although, endpoints 406-408 may include a similar display systems that perform similarly. Display system 800 includes display 811 and camera 821. Display 811 may be a cathode ray tube (CRT), Liquid Crystal Display (LCD), Light Emitting Diode display (LED), or some other type of display capable of presenting images described below. Camera 821 includes optics and an image sensor for capturing video of a participant viewing display 811. Camera 821 may be omitted in some examples. In some examples, display system 800 may further include a microphone and/or one or more speakers for participant 429 to input and receive voice communications over conference sessions.

In this example, endpoint 409 is currently connected to conference session 432, which is a video conference session, using a conference client application. Display 811 is displaying an example Graphical User Interface (GUI) for the conference client application. The GUI shows participant windows 831-833, participant list 834, chat channel window 835, and end call button 841, which ends endpoint 409′s connection to conference session 432 when pressed. Real-time video of participant 427 is shown in participant window 831, which is larger than participant window 832 and participant window 833 because participant 427 is currently speaking. Participant window 832 shows real-time video of participant 426 and participant window 833 shows real-time video of participant 428.

Display 811 is displaying an example of the GUI for the client application after the information described above with respect to display system 700 is sent from endpoint 402 over a communication channel established into conference session 432. Upon receipt of the information, endpoint 409 causes display 811 to display chat channel window 835 for chat channel 801 of conference session 432. Typically chat channel 801 is used for chat communications between participants currently on conference session 432. Participant 429 can type whatever message they want to sent into text entry box 837 and then send the message onto chat channel 801 by selecting send button 836. In this example, information received from endpoint 402 is presented in chat channel 801 because conference system 401 uses chat channel 801 of conference session 432 for the communication channel from endpoint 402 into conference session 432. Since chat channel 801 is for conference session 432 as a whole, the other participants 426-428 that are currently on conference session 432 will also see the information in chat channel windows for chat channel 801 being displayed by their respective endpoints 406-408. In this example, conference system 401 also updates the information in participant list 834 to list participants 426-429 as participants currently on conference session 432 and participants 422-423 as delayed participants who are not yet connected to conference session 432.

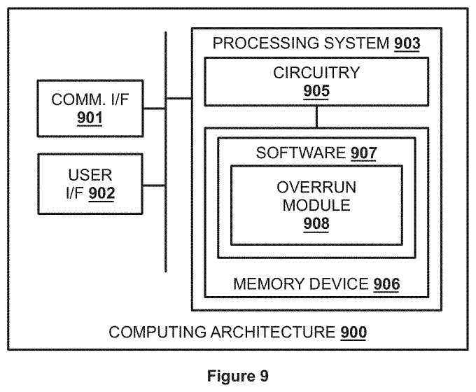

FIG. 9 illustrates computing architecture 900 for establishing a communication channel into a conference session for a subsequent meeting. Computing architecture 900 is an example computing architecture for conference systems 101 and 401, although systems 101 and 401 may use alternative configurations. Other systems described above, such as the endpoints, may also use computing architecture 900. Computing architecture 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a computer readable storage medium, such as a disk drive, flash drive, data storage circuitry, or some other memory apparatus. In no examples would a computer readable storage medium of memory device 906, or any other computer readable storage medium herein, be considered a transitory form of signal transmission (often referred to as “signals per se”), such as a propagating electrical or electromagnetic signal or carrier wave. Operating software 907 comprises computer programs, firmware, or some other form of machine-readable processing instructions. Operating software 907 includes overrun module 908. Operating software 907 may further include an operating system, utilities, drivers, network interfaces, applications, or some other type of software. When executed by processing circuitry 905, operating software 907 directs processing system 903 to operate computing architecture 900 as described herein.

In particular, overrun module 908 directs processing system 903 to, during a first meeting, determine a participant in the first meeting that is scheduled to participate in a second meeting following the first meeting. The participant operates a participant endpoint to participate in the first meeting over a first conference session established between the participant endpoint and other participant endpoints. Overrun module 908 directs processing system 903 to perform an overrun check that results in an overrun determination that the first meeting is going to extend beyond a scheduled start time of the second meeting. In response to the overrun determination, overrun module 908 directs processing system 903 to establish a communication channel between the participant endpoint and a second conference session for the second meeting while the participant endpoint remains on the first conference session. Overrun module 908 directs processing system 903 to transmit information from the participant over the communication channel to the second conference session.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
during a first meeting, determining a participant in the first meeting that is scheduled to participate in a second meeting following the first meeting, wherein the participant operates a client application executing on a participant endpoint to participate in the first meeting over a first conference session established between the participant endpoint and other participant endpoints;
performing an overrun check, wherein the overrun check results in an overrun determination that the first meeting is going to extend beyond a scheduled start time of the second meeting;
in response to the overrun determination, establishing a communication channel between the participant endpoint and a second conference session for the second meeting while the participant endpoint remains on the first conference session, wherein an interface for the communication channel is presented to the participant by the client application in an interface for the first conference session; and
transmitting information from the participant over the communication channel to the second conference session, wherein the information is received in the interface for the communication channel.

2. The method of claim 1, comprising:
in response to reaching a threshold amount of time prior to a scheduled end time of the first meeting, prompting the participant about whether the overrun check should be performed; and
in response to prompting the participant, receiving an instruction to perform the overrun check.

3. The method of claim 1, comprising:
determining whether core participants for the second meeting are available for the second meeting; and
in response to determining that there are one or more unavailable participants of the core participants, notifying the participant about the unavailable participants.

4. The method of claim 3, comprising:
in response to determining that there are one or more unavailable participants of the core participants, canceling the second meeting.

5. The method of claim 1, comprising:
in response to the overrun determination, presenting a status of the second meeting to the participant.

6. The method of claim 1, comprising:
in response to the overrun determination, presenting an estimated overrun time to the participant, wherein the information includes the estimated overrun time.

7. The method of claim 1, wherein the communication channel comprises a text chat channel and wherein the information comprises text entered by the participant into the participant endpoint.

8. The method of claim 1, wherein the interface for the communication channel comprises a popup window.

9. The method of claim 8, wherein the interface presents an estimated overrun time and wherein the information includes the estimated overrun time.

10. The method of claim 1, wherein the information is presented to one or more participants via the second conference session.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
during a first meeting, determine a participant in the first meeting that is scheduled to participate in a second meeting following the first meeting, wherein the participant operates a client application executing on a participant endpoint to participate in the first meeting over a first conference session established between the participant endpoint and other participant endpoints;
perform an overrun check, wherein the overrun check results in an overrun determination that the first meeting is going to extend beyond a scheduled start time of the second meeting;
in response to the overrun determination, establish a communication channel between the participant endpoint and a second conference session for the second meeting while the participant endpoint remains on the first conference session, wherein an interface for the communication channel is presented to the participant by the client application in an interface for the first conference session; and
transmit information from the participant over the communication channel to the second conference session, wherein the information is received in the interface for the communication channel.

12. The apparatus of claim 11, wherein the program instructions direct the processing system to:
in response to reaching a threshold amount of time prior to a scheduled end time of the first meeting, prompt the participant about whether the overrun check should be performed; and
in response to prompting the participant, receive an instruction to perform the overrun check.

13. The apparatus of claim 11, wherein the program instructions direct the processing system to:
determine whether core participants for the second meeting are available for the second meeting; and
in response to determining that there are one or more unavailable participants of the core participants, notify the participant about the unavailable participants.

14. The apparatus of claim 13, wherein the program instructions direct the processing system to:
in response to determining that there are one or more unavailable participants of the core participants, cancel the second meeting.

15. The apparatus of claim 11, wherein the program instructions direct the processing system to:
in response to the overrun determination, present a status of the second meeting to the participant.

16. The apparatus of claim 11, wherein the program instructions direct the processing system to:
in response to the overrun determination, present an estimated overrun time to the participant, wherein the information includes the estimated overrun time.

17. The apparatus of claim 11, wherein the communication channel comprises a text chat channel and wherein the information comprises text entered by the participant into the participant endpoint.

18. The apparatus of claim 11, wherein the interface for the communication channel comprises a popup window.

19. The apparatus of claim 18, wherein the interface presents an estimated overrun time and wherein the information includes the estimated overrun time.

20. One or more computer readable storage media having program instructions stored thereon that, when read and executed by a processing system, direct the processing system to:
during a first meeting, determine a participant in the first meeting that is scheduled to participate in a second meeting following the first meeting, wherein the participant operates a client application executing on a participant endpoint to participate in the first meeting over a first conference session established between the participant endpoint and other participant endpoints;
perform an overrun check, wherein the overrun check results in an overrun determination that the first meeting is going to extend beyond a scheduled start time of the second meeting;
in response to the overrun determination, establish a communication channel between the participant endpoint and a second conference session for the second meeting while the participant endpoint remains on the first conference session, wherein an interface for the communication channel is presented to the participant by the client application in an interface for the first conference session; and
transmit information from the participant over the communication channel to the second conference session, wherein the information is received in the interface for the communication channel.
